(19) United States
(12) Patent Application Publication
(10) Pub. No.: US 2005/0289005 A1
(43) Pub. Date: Dec. 29, 2005

(54) Systems and methods of achieving optimal advertising

(76) Inventors: John B. Ferber, Baltimore, MD (US); Scott Ferber, Baltimore, MD (US); Mark Hrycay, Baltimore, MD (US); Robert Luenberger, Palo Alto, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/132,731

(22) Filed: May 18, 2005

Related U.S. Application Data
(60) Provisional application No. 60/572,427, filed on May 18, 2004.

(51) Int. Cl. G06F 17/60

(52) U.S. Cl. 705/14

(57) ABSTRACT

A system and method for achieving optimal advertising is disclosed. In Internet advertising embodiments, small quantities of experimental advertising banner designs are tested to extract valuable information from the experiments. One or more embodiments can also incorporate array mathematics to help select and analyze the ad design elements that improve the results (e.g., click-thru-rate, revenue-per-impression, etc.) of the overall advertising campaigns. Embodiments of the present invention can also utilize a process of identifying influential design elements, selecting and testing banners representative of such design elements, obtaining feedback, and analyzing it to extract information from the experiments about which design elements are most important and which combination of design elements lead to the best overall banner. By providing substantive results via fewer test banner designs, the present invention decreases the costs associated with running advertising campaigns and otherwise improves the efficiency and success rates of an advertising provider.

### CROSS-REFERENCE TO RELATED APPLICATIONS

This application claims the benefit of U.S. provisional application No. 60/572,427, filed May 18, 2004, which is incorporated herein by reference.

### BACKGROUND OF THE INVENTION

1. Field of the Invention

The present invention relates generally to the allocation of the supply of products or services with the demand for the products or services in the most beneficial manner, and more specifically to systems and methods for optimizing advertising over the Internet.

2. Description of Related Art

Since the early 1990's, the number of people using the World Wide Web has grown at a substantial rate. As more users take advantage of the World Wide Web, they generate higher and higher volumes of traffic over the Internet. As the benefits of commercializing the Internet can be tremendous, businesses increasingly take advantage of this traffic by advertising their products or services online. These advertisements may appear in the form of leased advertising space (e.g., “banners”) on websites, which are comparable to rented billboard space on highways and in cities or commercials broadcast during television or radio programs.

The optimal placement of such ads has become a critical competitive advantage in the Internet advertising business. Consumers are spending an ever-increasing amount of time online looking for information, which is viewed on a page-by-page basis. Each page can contain written and graphical information as well as one or more ads. Key advantages of the Internet, relative to other information media, are that each page can be customized to fit a customer profile and that ads can contain links to other Internet pages. Thus, ads can be directly targeted at different customer segments and the ads themselves are direct connections to well-designed Internet pages. Although the present example has been described with respect to traditional Web browsing on a Web page, the same principles apply for any content, including information or messages, as well as advertisements, delivered over any Internet enabled distribution channel, such as via e-mail, wireless devices (including, but not limited to, phones, pagers, PDAs, desktop displays, and digital billboards), or other media, such as ATM terminals.

Beyond the simple act of merely placing a high enough number of ads to reach a desired number of customers, the overall broadcast functionality must be implemented under a comprehensive regime if the advertising campaign is to achieve the intended results. Ad placements are typically compensated based on the number of successful responses that they generate. The most successful regimes also allow for a minimum of wasted data manipulation. However, current methods of placing Internet ads are often unsatisfactory because they fail to take proper factors, information, and feedback into account, and/or they waste computer resources.

Both experience and common sense have shown that the design of a banner advertisement can affect the rate at which viewers respond. It is therefore important to have a systematic approach to identifying those banners that contain the elements that will be beneficial in terms of viewer response. Given the need for an efficient framework for successfully placing Internet ads, current methods of identifying ideal banners and placing Internet ads have significant drawbacks.

One drawback of current methods is that they often rely on inefficient and/or bulky procedures to accomplish their objectives. As the sophistication and data size requirements of desired ads as well as the demands of the associated system continue to increase dramatically, any unnecessary data manipulations or other waste of computer processing capability becomes extremely undesirable. Thus, current methodologies can impose additional burdens via their failure to execute efficient data processing operations.

A further drawback of current methods is the failure to use valuable feedback information in the provision of their advertising campaign. For example, acceptance and success data generated from the banners that have been displayed provides significant beneficial information about diverse aspects of the various possible ad banners. Failure to utilize such feedback information places additional burden on these systems in areas such as the effectiveness of subsequent data processing.

Interrelated to these last two issues is the drawback that current methods are often unable to decide which ad is ideal. Preferably, an advertising regime should provide astute predictions as to which ad is the best ad to display under the given circumstances. For example, the best ad for a given set of circumstances might be determined by particular methodological analysis, mathematical modeling or other computation, and/or by utilizing updated ad-related data (e.g., success data, etc.) or via other feedback. To the extent that present methods cannot predict the best ad or ads to display, a burden to successful advertising clearly exists.

Further drawbacks exist in systems and methods that fail to take into account cost-efficiency and feasibility considerations. For example, to show a banner advertisement on a webpage, advertisers typically purchase space on a per-impression basis. As such, there is a cost associated with each showing of the banner. Conversely, many advertisers (or their agents) are interested in clicks or actions. Thus, each showing of a banner constitutes a risky investment because the cost is certain but the value or revenue is not. Advertisers must therefore use the rental space efficiently. Beyond this cost issue is the issue of whether conducting exhaustive tests is feasible. Most advertising campaigns have a limited duration measured in time, money, impressions, actions, or some related quantity. Testing even a moderate number of design elements in a fully exhaustive manner would require more than a reasonable contract size would allow in many instances. Often present systems are unsatisfactory because they fail to take these considerations into account.

Banner design can cover various aspects or elements, such as the color, the message, the animation, where items are placed within the banner, and many others. As it is desirable to have a process of on-going improvement, it is important to not only identify those banners that are likely to perform best, but to be able to isolate those elements most influential in causing this. One can then focus on acquiring additional information about those aspects. Additional drawbacks are therefore present in systems and methods that fail to analyze which factors drive performance.

Accordingly, there is a need for systems and methods that allow advertising clients to create, place, and modify advertising campaigns in the most efficient and effective manner. Furthermore, there is a need for systems and methods that provide advertising regimes that utilize scientific procedures to determine desired design elements and accurately decide the ads to be displayed.

### SUMMARY OF THE INVENTION

In accordance with the invention, systems and methods for achieving optimal advertising are proposed. With respect to a first exemplary method, a method for optimal determination of advertisements for display is disclosed, the method comprising the steps of selecting a test design keyed to variables relating to an ad, creating ad media according to the test design, serving the ad media to ad recipients, collecting result data regarding the serving/service of the ad media, analyzing the result data, including (i) obtaining performance data based on the result data, and (ii) determining performance along each variable via processing that includes array mathematics, determining projections for the variables.

With respect to a second exemplary method, another method of determining optimal advertisements for display is disclosed, the method comprising the steps of determining one or more variables to analyze, selecting one or more elements from each of the one or more variables, wherein the one or more elements are values to which output results of the analysis pertain; determining combinations of the one or more elements to distribute via application of a test design array/matrix, creating ad images according to the determined combinations, serving the ad images to customers, tracking the ad images to yield results, analyzing the results, including: (i) obtaining performance data based on the results, and (ii) determining performance along each variable, and reporting projections for all combinations of variables.

With respect to a third exemplary method, a method of processing result data obtained from the service of ads to ad recipients is disclosed, the method comprising the steps of identifying variables associated with the ads for analysis, acquiring a test design array having parameters corresponding to the identified variables, obtaining first performance data based on result data obtained from service of the ads, determining second performance data along each of the variables via processing that includes application of an orthogonal array; and calculating a projection for a best ad to be served.

One or more systems for achieving optimal advertising according to the above methodologies are also disclosed. According to these embodiments, systems of the present invention can include an ad banner generating component that generates ads, an ad server configured to serve the ads to ad recipients, a processing component configured to process success-related information concerning distribution of the ads, a database component that stores data concerning the ads, and a computing component including a computer readable medium storing a program of instructions embodying a program of instructions operable by a computer to execute aspects of the methods set forth above.

Articles of manufacture, computer readable media, and computer program products are also disclosed. Embodiments of the invention pertaining to these aspects are comprised of articles, media or products that embody a program of instructions operable by a computer to execute the methods set forth above or aspects of these methods.

It is an advantage that ad placement technology of embodiments of the present invention provides an optimal strategic framework for selecting which ad a customer will view next. Such embodiments maximize the overall expected ad placement revenue (or other measure of value), and can trade off the desire for learning with revenue generation. The technology can be executed in “real-time” and updates the strategy space for every customer.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and, together with the description, serve to explain the principles of the invention.

### BRIEF DESCRIPTION OF THE DRAWINGS

FIG. 1 is a block diagram of an exemplary computer system used to implement the present invention, according to one or more embodiments; and

FIG. 2 is a diagram illustrating an exemplary process for implementing ad banners, according to one or more embodiments of the present invention.

FIG. 3 is a flow chart illustrating an exemplary method of performing an analysis on data, according to one or more embodiments of the present invention.

FIG. 4 is a chart illustrating examples of orthogonal arrays available for the inventive analysis, according to one or more embodiments of the present invention.

### DESCRIPTION OF THE EMBODIMENTS

Reference will now be made in detail to the present embodiments of the invention, which are merely representative of the invention. Examples of these embodiments are illustrated in the accompanying drawings. Wherever possible, the same reference numbers will be used throughout the drawings to refer to the same or like parts.

Notably, as used herein, the term “ad” is also meant to include any content, including information or messages, as well as advertisements, such as, but not limited to, Web banners, product offerings, special non-commercial or commercial messages, or any other displays, graphics, video or audio information. The definitions of other terms used throughout this application, such as “Web page,” “Internet,” “customer,” “user,” “revenue,” terms related to these terms, and other terms, are set forth more fully in the glossary section below.

Furthermore, in this application, the use of the singular includes the plural unless specifically stated otherwise. In this application, the use of “or” means “and/or” unless stated otherwise. Furthermore, the use of the term “including”, as well as other forms, such as “includes” and “included,” is not limiting. Also, terms such as “element” or “component” encompass both elements and components comprising one unit and elements and components that comprise more than one subunit unless specifically stated otherwise.

The section headings used herein are for organizational purposes only, and are not to be construed as limiting the subject matter described. All documents cited in this application, including, but not limited to, patents, patent applications, articles, books, and treatises, are expressly incorporated by reference in their entirety for any purpose.

Advertisers, advertising networks, and other entities are interested in running efficient advertising campaigns on the Internet. A typical contract will specify both a budget and a time period during which the advertising campaign will run. As all parties are often interested in specific actions being caused (e.g., clicks or sales), an important part of an overall delivery algorithm is a trade-off between learning which banners are effective and showing those banners that are already known to be effective.

Furthermore, advertisers often would like their advertising campaigns to be run “smoothly” during the time period. For example, if the campaign has a budget of $30,000 and lasts for 30 days, they might like approximately $1,000 to be used each day. Moreover, the advertiser may impose other restrictions such as not allowing the campaign to appear on certain websites, during certain times of the day, or other constraints. Given these desires of the advertisers, the need for an efficient method of testing advertising banners is clear.

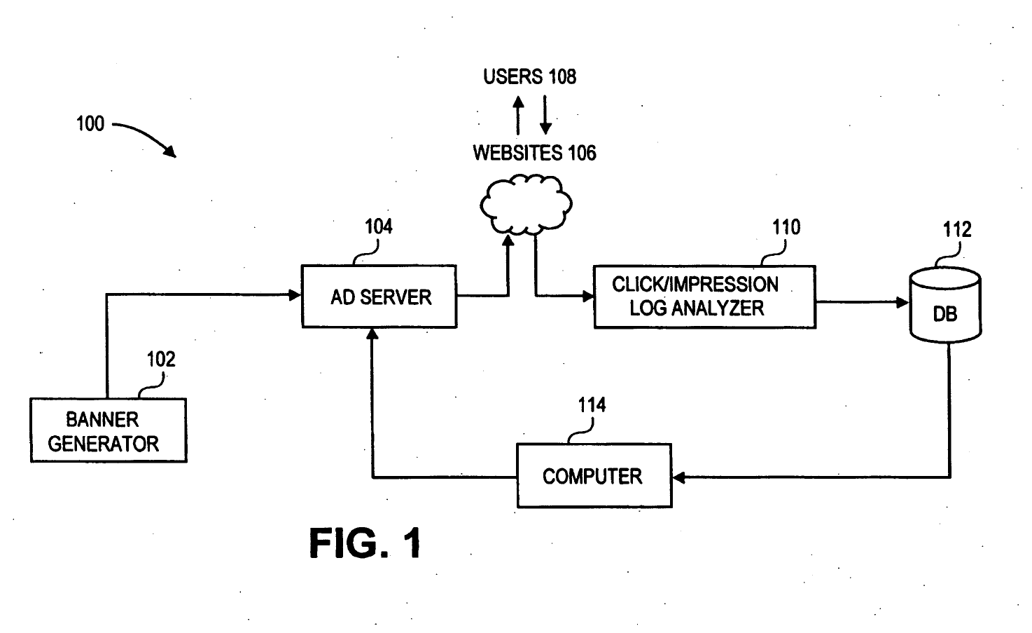

Exemplary system architecture for the embodiments of systems and methods for ad generation disclosed throughout this specification is set forth as follows. FIG. 1 depicts an exemplary ad generation system 100 consistent with one or more embodiments of the present invention. The components of system 100 can be implemented through any suitable combinations of hardware, software, and/or firmware. As shown in FIG. 1, according to one or more embodiments, system 100 may include at least one banner generating component 102, ad server 104, website 106, user 108, click/impression log analyzer 110, database 112, computer 114, and network (e.g., network 105 and/or any other computer data network that allows communication to occur amongst any/all components of the system). Such networks may be any network and/or combination of networks, including, for example, the Internet. According to such systems, then, ads can be served to users 108 (or ad recipients) via any suitable network.

The system elements are detailed below, according to one or more embodiments of the present invention. The banner generating component 102 can be a machine such as a personal computer with picture making software to create banner advertisements suitable for display on websites. The ad-server 104 can be one or more ad-server computers capable of receiving the banner advertisements and the instructions about where and when to serve them and carrying out these instructions. Website 106 can be a website that has agreed (possibly in return for payment) to display the banners served by the ad-servers. User 108 can represent one of the users that view the websites 106 and that are therefore also viewing the banner advertisements. The click/impression log analyzer 110 is a click/impression analyzer used to determine the results of the showing(s) of the banner advertisements. The database 112 can be a database used to store the results of the showing(s) of the banner advertisements. The computer 114 can be a control-related computer used to handle the scheduling of the ads and to provide instructions to the ad-servers.

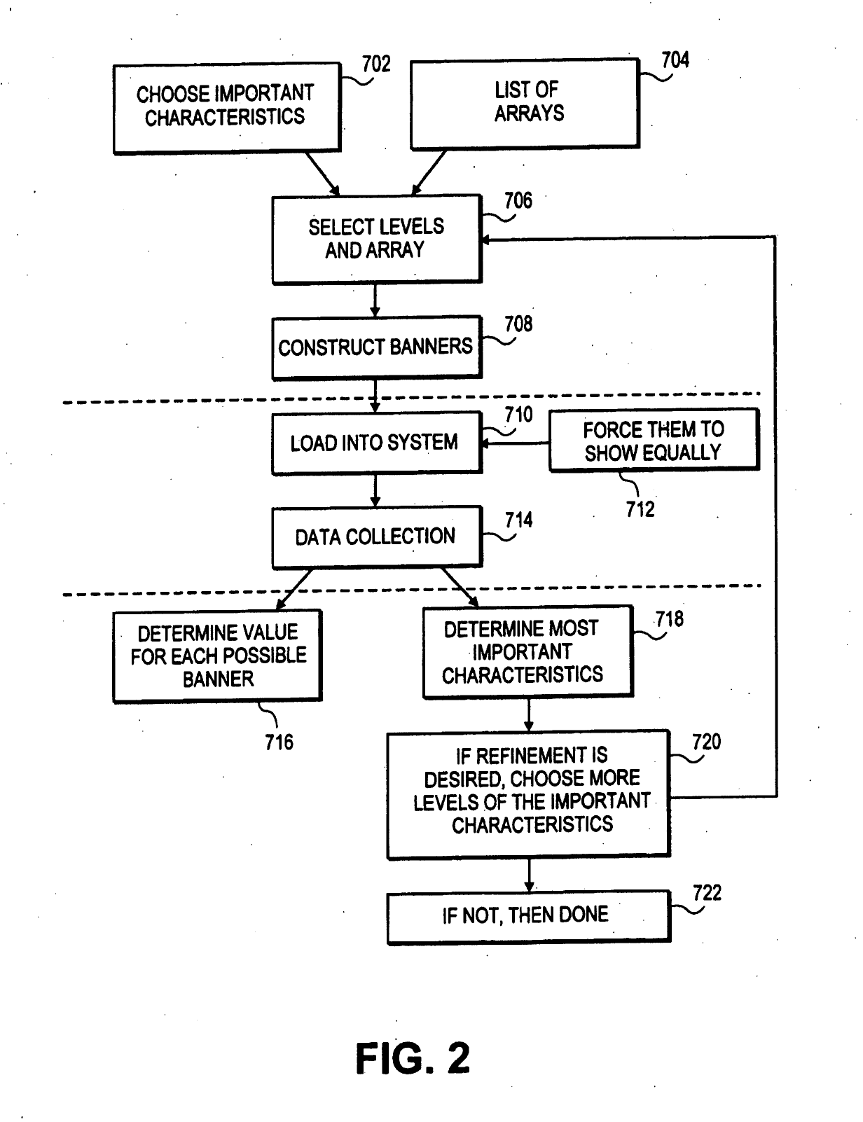

Next are addressed the procedures and methodology of the scientific banner generation and implementation process. This methodology is set forth in association with an exemplary Taguchi array, with the steps of this exemplary method being illustrated in FIG. 2. For purposes of discussion and illustration, we divide the overall experimentation into three sections: phase 1, preparing for the test; phase 2, conducting the test; and phase 3, analyzing the data. Depending on the results of the data, we may be finished or we may adjust our preparation and repeat portions of the process one or more times.

In the initial phase, steps are taken in preparation for the test. First, based largely on experience and rational advertising know-how, the test designer chooses a number of characteristics 702 of the proposed banners that may influence the effectiveness of the banner. Typical choices would be color, animation, message, etc. Each of these characteristics will have a corresponding number of possible levels, which are then selected by the designer 706. For example, if the characteristic were color, the levels might be blue, red, and green. As not all combinations of the number of characteristics and the number of levels combine to form arrays that may be validly analyzed, the selection of these numbers must be done in consultation with a list of arrays 704 that are valid. Such a list is appended here as Exhibit A.

Once this is done, the resulting banners are physically constructed in the manner typical of this practice 708. This is simply creating a picture with the characteristics set to the appropriate levels as specified until all necessary banners have been created.

The designer will then move into Phase 2, running the test. Once created, the banners are loaded into the ad serving system 710 in the normal manner for whatever ad server is being deployed. Nothing here depends on how ads are served.

Using the algorithm(s) that control which ads will be served, the program or the designer then sets the ads just created to serve in a way that is identical for each of them, forcing them to show equally 712. For example, if an ad is requested from a particular website, each of the ads should have an equal chance of being shown, or the ads should be shown in a fair rotation, or in a similar scheme. Minor discrepancies here will not affect the overall procedure in a meaningful way.

Each time there is an event that corresponds to the banner being successful, this event is recorded. Typically, this will be a viewer clicking on the ad or a user making a purchase as a result of having seen the ad. Such event logging and storage is standard within the Internet advertising industry. This data collection procedure 714 should continue until there is statistically significant data about the banners, using definitions standard within the statistics community.

The process then moves into phase 3, analyzing the data. Next, the procedure determines the value for each possible banner 716 (see example below). For the banners that were created the values associated with relevant success criteria are compared. For example, this would typically be the click-thru-rate (the percent of times viewers clicked on an ad when they were shown it), or the revenue-per-view.

Using matrix array methodology (for example, the Taguchi method), the next step is to determine which of the chosen banners is most important in terms of the criteria specified (e.g., click-thru-rate) 718.

Next, a refinement step can be executed, step 720. Here, if one or more characteristics are deemed important based on the above refinement, then additional levels of that characteristic may be tested (e.g., if color is found to be important, but if only two colors were tested then several additional colors may now be added for testing). In this case, the algorithm returns to step 706 and selects characteristics and levels appropriately. Otherwise, (if no additional testing is needed) banners that are the most successful according to the chosen criteria are selected, and running of these banners is continued 722.

For a given campaign, many ways exist to design the banners, and different designs result in different performance. Even with a relatively small number of design elements, the total number of combinations is very high. But testing many banners on the network is expensive.

To illustrate application of such matrix/mathematical modeling in real world banner design, an exemplary experiment design follows. As seen below, we can identify the best setting for each design element and those that are most important by carefully choosing certain banners to test.

In essence, for embodiments such as this, by assuming that interactions between design elements are not the dominant factor, the number of banners needed for testing can be dramatically reduced. In Taguchi methods, for example, which are a specialized application of statistical methods used for experiment design, the number of combinations and levels for a given set of parameters are dramatically reduced by neglecting the effects of parametric interactions. For example, a full analysis of 13 parameters each taking 3 values would require 3¹³=1,594,323 experiments. However, using Taguchi methods, it is possible to determine the predominant effects of the parameters at the various levels with only 27 experiments (for example, see Exhibit A). As the number of parameters and levels increase, so does the advantage of the Taguchi method. The Taguchi method uses unbiased orthogonal arrays, and therefore is the most efficient unbiased set of experiments to capture the primary effects of a system. In an orthogonal array (see, for example, Exhibit A) experiment repetition is avoided because no column can be created by the combination of any other columns. Moreover, the experiments are unbiased because for each level of a parameter, all other parameter levels are equally represented. Thus, Taguchi methods allow for a computationally efficient design of experiments, in order to understand the relative importance of various parameters.

For example, in a situation where there are three design elements (parameters), each taking two possible values (levels): first, Color, which may take the values of Red (C1) or Blue (C2); second, the Message, which may take the values of “act now” (M1) or “save 10%” (M2); and, lastly, the Banner Animation, which can have the values of none (no banner animation) (A1) or blinking banner animation (A2). The Taguchi array has 4 experiments (see, for example, Exhibit A)

Thus, although there are a total of 8 possible banners, by constructing an orthogonal array such as, here, a Taguchi array, we will be able to learn almost everything by testing only 4 banners.

EXEMPLARY ARRAY

| Banner | Color (C) | Message (M) | Animation (A) |
|---|---|---|---|
| B1 | 1 | 1 | 1 |
| B2 | 1 | 2 | 2 |
| B3 | 2 | 1 | 2 |
| B4 | 2 | 2 | 1 |

This array is both orthogonal and unbiased, as can be seen, for example, by looking at the color dimension.
When color is 1:
   Message takes on the value 1 once, and 2 once, and
   Animation takes on the value 1 once, and 2 once
When color is 2:
   Message takes on the value 1 once, and 2 once, and
   Animation takes on the value 1 once, and 2 once

Thus, for each value of the color parameter, the levels of the other parameters are equally represented. The results of using such array organization are a great improvement over prior methods. Now, assume that these four banners were run, with experiments corrected for time-of-day effects, etc. and found the following RPM's on a site:

EXEMPLARY ARRAY

| Banner | Result (RPM) |
|---|---|
| B1 | 1.9 |
| B2 | 1.0 |
| B3 | 2.5 |
| B4 | 2.3 |

Thus, analyzing the results, we can note certain second-level results by manipulating (e.g., averaging, etc.) the basic RPM results:
C1=(B1+B2)/2=(1.9+1.0)/2=1.45
C2=(B3+B4)/2=(2.5+2.3)/2=2.40
M1=(B1+B3)/2=(1.9+2.5)/2=2.20
M2=(B2+B4)/2=(1.0+2.3)/2=1.65
A1=(B1+B4)/2=(1.9+2.3)/2=2.10
A2=(B2+B3)/2=(1.0+2.5)/2=1.75
In some embodiments, the best second level results for each of the parameters, represented by C2, M1, A1, are chosen.

Note that B1 and B2 are averaged because they correspond to color C1, i.e. Red. Similarly, averaging B1 and B3, yields results for Message M1, i.e. “act now”. In some embodiments, the best second level results for each of the parameters are chosen. For the purposes of the current illustrative example, the parameters chosen would be represented by C2, M1, and A1. Therefore, the recommendation would be: Color=Blue; Message=Act Now; and Animation=None. Notice that the banner that was recommended was not one that was even tested—allowing deducement of the best results for all possible combinations.

It is also possible to find which parameters are the most influential by further mathematical manipulations. For example, if we take the difference between the RPM values for each of the color (C), message (M), and animation (A) categories:
C2−C1=0.95
M1−M2=0.55
A1−A2=0.35

Therefore, color (C) is the most important aspect or dimension because a change in the color dimension here yields the largest RPM difference. This suggests that a user click-through is influenced by color to a greater extent than other parameters. This type of data manipulation also allows for focus and improvement of areas of banner design that will benefit the most from such feedback. Here, for example, the mathematical manipulations indicate that other colors should be experimented with to determine the most beneficial way to improve customer response.

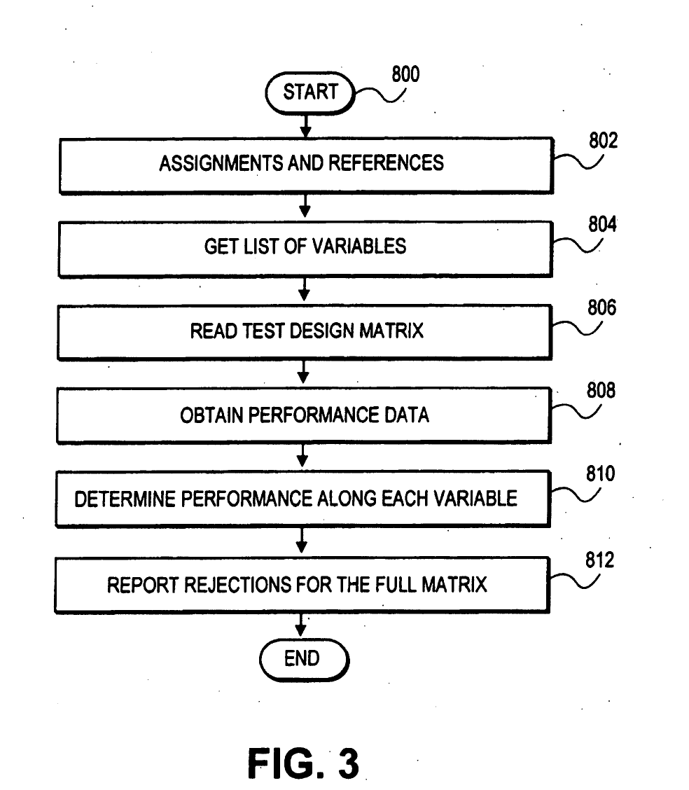

FIG. 3 is a flowchart showing steps of an embodiment of a Taguchi analysis method. In some embodiments, the exemplary algorithm shown in FIG. 3 may be used as a data analysis component of the complete test methodology, and may be incorporated into a program that includes steps of the exemplary scientific banner generation embodiment described in FIG. 3. In some embodiments, the algorithm may be applied after a test design has been selected, the constituent media (banners, for example) have been served to users, and the individual level results data has been aggregated from the ad-serving system. In some embodiments, the algorithm of FIG. 3 may be used to analyze data, retrieve that data, and display the results of the test in HTML form to the end user.

The algorithm starts in step 800. Next, in step 802, the initialization of variables, addresses, and locations from which the data is read and written is performed. For example, files containing data to be analyzed may be read and files required to hold the results of the analysis may be opened. In step 804, a list of variables that are to be analyzed is obtained. In some embodiments, the variable list could be the parameters or characteristics selected for testing by the algorithm of FIG. 2. In some embodiments, the variable list may be stored in a file. In some embodiments, the variable list may be obtained from another program or read from memory. In some embodiments the variable list may be obtained from database 112. Each variable may be assigned a label to be used in the program and output according to embodiments of the invention. Next, in step 806, the test design matrix is read. The test design matrix indicates the properties of the constituent media (for example, characteristics of banners that were tested) such that an analysis on those properties may be conducted. An unbiased orthogonal test design matrix may be used as described earlier, according to embodiments of the invention.

In step 808, performance data resulting from web-user interaction with banners is obtained. In some embodiments, the program can read the impression, click, conversion, and revenue data from the ad-serving database 112. In some embodiments, the data stored within the ad-serving system is stored specific to the constituent media. In some embodiments, the program may be used to analyze individual attributes of the media used. In some embodiments, the analyzed media level data may be combined with corresponding attribute data, the results summarized at the media level, and the information output.

In step 810, summary data for each variable is generated. In some embodiments, the program may calculate the summary data for each variable independently from the others. According to embodiments of the invention where the test design matrix is orthogonal, as in a Taguchi array, the data for each element may be summed or otherwise manipulated without concern for the influence of the other variables within the test. In some embodiments, the program may be implemented with an internal loop, which iterates over each variable, performing multiple levels of analysis. For example, one level could include a summary across all network placements. Another level could split out the largest web placements to determine to what extent the effects demonstrated are established consistently across all placements. For example, since the effects of the levels of certain parameters on click-through rates may vary based on the sites on which they are displayed, in some embodiments, another level of analysis may be performed whereby the consistency of the results is checked by looking at the biggest sites. In some embodiments, the summary level data for each variable may be displayed in this step. In some embodiments, the individual placement data, which contains both the performance by placement and a summary of how often each element earns each relative ranking may also be displayed.

In step 812, the program reports projections for the full matrix. In this step the relative performance of each variable/element combination is joined in order to project out the attributes of the best possible media. It is important to note that the new or chosen attribute combination might not be any of the constituent media used in the test, but rather a composite of all the best attributes as determined from those media. The projection relies on the assumption that all of the elements are independent, so the projection is simply a linear combination of the performance of the individual elements. In some embodiments, this projection may also be output.

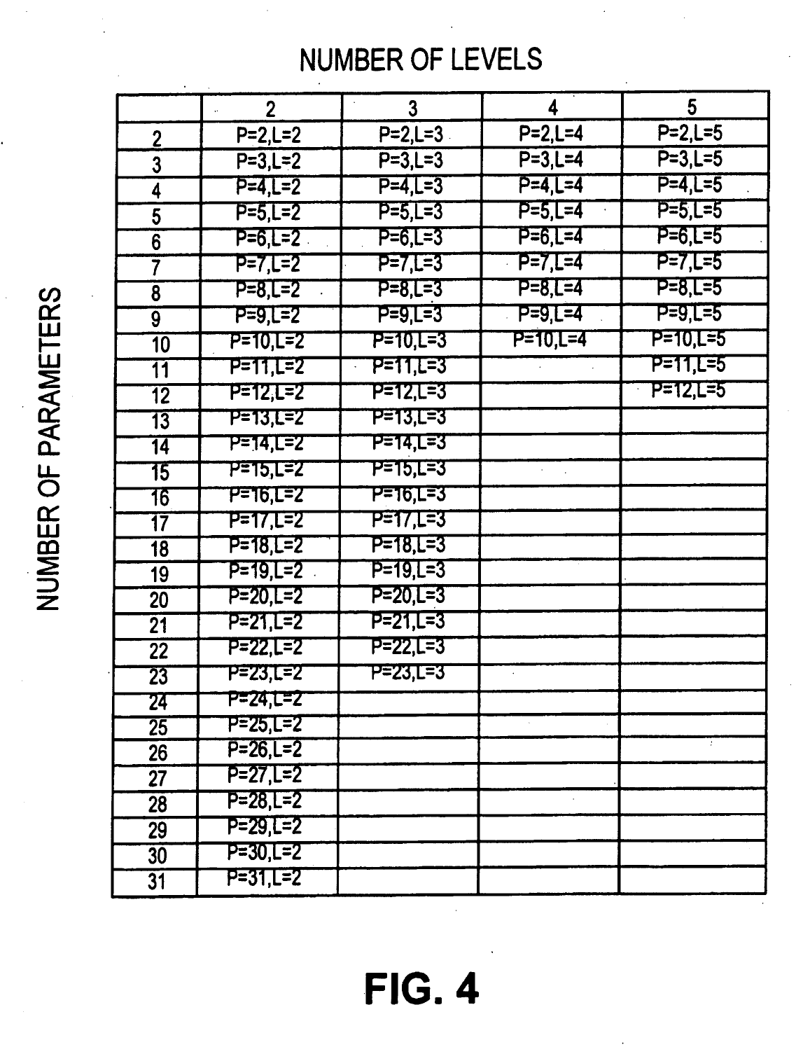

FIG. 4 is a chart illustrating examples of orthogonal arrays available for the inventive analysis, according to one or more embodiments of the present invention. As can be seen from the figure, only certain quantities of parameters (the “P” numbers listed in FIG. 4) having certain quantities of variables or levels (the “L” numbers listed in FIG. 4) are suitable for manipulation via use of orthogonal array mathematics. Thus, FIG. 4 indicates the orthogonal array analysis regimes available according to the embodiments of the present invention that involve such processing.

According to one or more exemplary embodiments of the present invention, the following items may be used to implement the computer processing methodologies set forth herein: (1) a functioning copy of the SAS language, with a license, installed on an appropriate machine; (2) a computer to run the program implemented with the SAS language, including a compatible operating system such as Windows; and (3) a connection to the database, such as ODBC for reading and writing. Note that the program code, language, environment, computers, operating systems, databases and any other elements of the system may be changed appropriately as desired and would be apparent to one skilled in the art.

The tables attached hereto as Appendix A, Tables 1 through Table 25, show the test parameters, results and analyses of exemplary experiments as could be conducted on web sites with ads using various parameters with levels.

Table 1 shows the parameters, their levels, and the experiments run, along with the results for each experiment. The purpose of the analysis program is to break down this experimental data into a relative performance for each attribute/element.

Tables 2 through 8 show the results for individual parameter levels. This is found by aggregating the data for all experiments with that value. This data is used to determine which parameters are drivers of performance, and which levels within those parameters have better performance.

The next set of tables (Tables 9 through 22) can be read in pairs. For example, Table 9 ranks the levels of the Concept parameter based on RPM, for various placements. Table 10 ranks by frequency, the number of times that each Concept level was ranked first or second at the various placements. Likewise, Tables 11-22 perform similar analyses for each of the other parameters shown in Table 1. This data may be used to determine how consistent the performance of the level is across placements by looking at its performance for the 5 highest volume placements. In some scenarios, a single dominant level, which has the highest performance across all placements, may be found. To the extent that results are mixed, additional experiments may be needed to determine if there are interaction effects between parameters.

Finally, Table 23 shows the projected performance for the full-matrix based on the experimental results. In this example, the projected performance for 128 possible ads is shown based on data collected from running only 8 experiments. The projection is found by combining the relative performance of each attribute (level) of the ad into a single score.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### Glossary

The term “ad” is also meant to include any content, including information or messages, as well as advertisements, such as, but not limited to, Web banners, product offerings, special non-commercial or commercial messages, or any other sort of displayed or audio information.

The terms “Web page,” “website,” and “site” are meant to include any sort of information display or presentation over an Internet enabled distribution channel that may have customizable areas (including the entire area) and may be visual, audio, or both. They may be segmented and or customized by factors such as time and location. The term “Internet browser” is any means that decodes and displays the above-defined Web pages or sites, whether by software, hardware, or utility, including diverse means not typically considered as a browser, such as games.

The term “Internet” is meant to include all TCP/IP based communication channels, without limitation to any particular communication protocol or channel, including, but not limited to, e-mail, News via NNTP, and the WWW via HTTP and WAP (using, e.g., HTML, DHTML, XHTML, XML, SGML, VRML, ASP, CGI, CSS, SSI, Flash, Java, JavaScript, Perl, Python, Rexx, SMIL, Tcl, VBScript, HDML, WML, WMLScript, etc.).

The term “customer” or “user” refers to any consumer, viewer, or visitor of the above-defined Web pages or sites and can also refer to the aggregation of individual customers into certain groupings. “Clicks” and “click-thru-rate” or “CTR” refers to any sort of definable, trackable, and/or measurable action or response that can occur via the Internet and can include any desired action or reasonable measure of performance activity by the customer, including, but not limited to, mouse clicks, impressions delivered, sales generated, and conversions from visitors to buyers. Additionally, references to customers “viewing” ads is meant to include any presentation, whether visual, aural, or a combination thereof.

The term “revenue” refers to any meaningful measure of value, including, but not limited to, revenue, profits, expenses, customer lifetime value, and net present value (NPV).

### Appendix A

TABLE 1
Test Creative Performance

| | | | | | Disclaimer | | | | | | |
|---|---|---|---|---|---|---|---|---|---|---|---|
| Obs | Concept | Color | CalltoAction | Elephant | Placement | ClickButton | Image | experiment | impressions | revenue | rpm |
| 1 | Bulleted | Dark/Light | Show support | Yes | Bottom | Yes | Bush | 5 | 436234 | 942.50 | 2.16054 |
| | List | | | | | | Outdoors | | | | |
| 2 | Economy | Dark/Light | Learn more | Yes | Top | Yes | Bush/Flag | 1 | 510020 | 803.50 | 1.57543 |
| 3 | Economy | Dark/Light | Learn more | No | Bottom | No | Bush | 2 | 490453 | 891.75 | 1.81822 |
| | | | | | | | Outdoors | | | | |
| 4 | Economy | Red/White/ | Show support | Yes | Top | No | Bush | 3 | 412986 | 648.50 | 1.57027 |
| | | Blue | | | | | Outdoors | | | | |
| 5 | Economy | Red/White/ | Show support | No | Bottom | Yes | Bush/Flag | 4 | 498054 | 923.00 | 1.85321 |
| | | Blue | | | | | | | | | |
| 6 | Bulleted | Dark/Light | Show support | No | Top | No | Bush/Flag | 6 | 446729 | 717.50 | 1.60612 |
| | List | | | | | | | | | | |
| 7 | Bulleted | Red/White/ | Learn more | Yes | Bottom | No | Bush/Flag | 7 | 432604 | 777.50 | 1.79726 |
| | List | Blue | | | | | | | | | |
| 8 | Bulleted | Red/White/ | Learn more | No | Top | Yes | Bush | 8 | 413896 | 816.50 | 1.97272 |
| | List | Blue | | | | | Outdoors | | | | |

TABLE 2
Performance Summary by Concept, rncemaqacjan04

| Obs | Concept | impressions | revenue | rpm |
|---|---|---|---|---|
| 1 | Bulleted List | 1729463 | 3254.00 | 1.88151 |
| 2 | Economy | 1911513 | 3266.75 | 1.70899 |

TABLE 3
Performance Summary by Color, rncemaqacjan04

| Obs | Color | impressions | revenue | rpm |
|---|---|---|---|---|
| 1 | Dark/Light | 1883436 | 3355.25 | 1.78145 |
| 2 | Red/White/Blue | 1757540 | 3165.50 | 1.80110 |

TABLE 4
Performance Summary by CalltoAction, rncemaqacjan04

| Obs | CalltoAction | impressions | revenue | rpm |
|---|---|---|---|---|
| 1 | Learn more | 1846973 | 3289.25 | 1.78089 |
| 2 | Show support | 1794003 | 3231.50 | 1.80128 |

TABLE 5
Performance Summary by Elephant, rncemaqacjan04

| Obs | Elephant | impressions | revenue | rpm |
|---|---|---|---|---|
| 1 | No | 1849132 | 3348.75 | 1.81098 |
| 2 | Yes | 1791844 | 3172.00 | 1.77024 |

TABLE 6
Performance Summary by DisclaimerPlacement, rncemaqacjan04

| Obs | DisclaimerPlacement | impressions | revenue | rpm |
|---|---|---|---|---|
| 1 | Bottom | 1857345 | 3534.75 | 1.90312 |
| 2 | Top | 1783631 | 2986.00 | 1.67411 |

TABLE 7
Performance Summary by ClickButton, rncemaqacjan04

| Obs | ClickButton | impressions | revenue | rpm |
|---|---|---|---|---|
| 1 | No | 1782772 | 3035.25 | 1.70255 |
| 2 | Yes | 1858204 | 3485.50 | 1.87574 |

TABLE 8
Performance Summary by Image, rncemaqacjan04

| Obs | Image | impressions | revenue | rpm |
|---|---|---|---|---|
| 1 | Bush Outdoors | 1753569 | 3299.25 | 1.88145 |
| 2 | Bush/Flag | 1887407 | 3221.50 | 1.70684 |

TABLE 9
Performance on Major Sites by Concept, rncemaqacjan04

| Obs | WEBMASTERID | Concept | impressions | revenue | rpm | rank |
|---|---|---|---|---|---|---|
| 1 | 69834 | Bulleted List | 54550 | 122.25 | 2.24106 | 1 |
| 2 | 69834 | Economy | 66828 | 11925 | 1.78443 | 2 |
| 3 | 95012 | Bulleted List | 113923 | 267.25 | 2.34588 | 1 |
| 4 | 95012 | Economy | 95771 | 215.50 | 2.25016 | 2 |
| 5 | 103339 | Bulleted List | 92901 | 150.75 | 1.62270 | 1 |
| 6 | 103339 | Economy | 97450 | 158.00 | 1.62134 | 2 |
| 7 | 137170 | Bulleted List | 56413 | 293.75 | 5.20713 | 1 |
| 8 | 137170 | Economy | 40124 | 181.50 | 4.52348 | 2 |
| 9 | 681224 | Bulleted List | 35703 | 123.00 | 3.44509 | 2 |
| 10 | 681224 | Economy | 34746 | 123.50 | 3.55437 | 1 |

TABLE 10
RPM Ranking Frequencies for Concept, rncemaqacjan04
The FREQ Procedure

| | |
|---|---|
| Frequency | |
| Percent | Table of Concept by rank |

| | |
|---|---|
| Row Pct | rank |

| | | | | |
|---|---|---|---|---|
| Col Pct | Concept | 1 | 2 | Total |

| | | | |
|---|---|---|---|
| Bulleted List | 4 | 1 | 5 |
| | 40.00 | 10.00 | 50.00 |
| | 80.00 | 20.00 | |
| | 80.00 | 20.00 | |
| Economy | 1 | 4 | 5 |
| | 10.00 | 40.00 | 50.00 |
| | 20.00 | 80.00 | |
| | 20.00 | 80.00 | |
| Total | 5 | 5 | 10 |
| | 50.00 | 50.00 | 100.00 |

TABLE 11
Performance on Major Sites by Color, rncemaqacjan04

| Obs | WEBMASTERID | Color | impressions | revenue | rpm | rank |
|---|---|---|---|---|---|---|
| 1 | 69834 | Dark/Light | 74781 | 147.00 | 1.96574 | 2 |
| 2 | 69834 | Red/White/Blue | 46597 | 94.50 | 2.02803 | 1 |
| 3 | 95012 | Dark/Light | 93190 | 190.50 | 2.04421 | 2 |
| 4 | 95012 | Red/White/Blue | 116504 | 292.25 | 2.50850 | 1 |
| 5 | 103339 | Dark/Light | 96021 | 156.00 | 1.62464 | 1 |
| 6 | 103339 | Red/White/Blue | 94330 | 152.75 | 1.61932 | 2 |
| 7 | 137170 | Dark/Light | 50676 | 256.00 | 5.05170 | 1 |
| 8 | 137170 | Red/White/Blue | 45861 | 219.25 | 4.78075 | 2 |
| 9 | 681224 | Dark/Light | 40609 | 144.50 | 3.55832 | 1 |
| 10 | 681224 | Red/White/Blue | 29840 | 102.00 | 3.41823 | 2 |

TABLE 12
RPM Ranking Frequencies for Color, rncemaqacjan04
The FREQ Procedure

| | |
|---|---|
| Frequency | Table |

| | |
|---|---|
| Percent | of Concept by rank |

| | |
|---|---|
| Row Pct | rank |

| | | | | |
|---|---|---|---|---|
| Col Pct | Color | 1 | 2 | Total |

| | | | |
|---|---|---|---|
| Dark/Light | 3 | 2 | 5 |
| | 30.00 | 20.00 | 50.00 |
| | 60.00 | 40.00 | |
| | 60.00 | 40.00 | |
| Red/White/Blue | 2 | 3 | 5 |
| | 20.00 | 30.00 | 50.00 |
| | 40.00 | 60.00 | |
| | 40.00 | 60.00 | |
| Total | 5 | 5 | 10 |
| | 50.00 | 50.00 | 100.00 |

TABLE 13
Performance on Major Sites by CalltoAction, rncemaqacjan04

| Obs | WEBMASTERID | CalltoAction | impressions | revenue | rpm | rank |
|---|---|---|---|---|---|---|
| 1 | 69834 | Learn more | 63739 | 127.25 | 1.99642 | 1 |
| 2 | 69834 | Show support | 57639 | 114.25 | 1.98216 | 2 |
| 3 | 95012 | Learn more | 126477 | 305.75 | 2.41744 | 1 |
| 4 | 95012 | Show support | 83217 | 177.00 | 2.12697 | 2 |
| 5 | 103339 | Learn more | 93044 | 151.25 | 1.62557 | 1 |
| 6 | 103339 | Show support | 97307 | 157.50 | 1.61859 | 2 |
| 7 | 137170 | Learn more | 44683 | 222.25 | 4.97393 | 1 |
| 8 | 137170 | Show support | 51854 | 253.00 | 4.87908 | 2 |
| 9 | 681224 | Learn more | 34672 | 121.00 | 3.48985 | 2 |
| 10 | 681224 | Show support | 35777 | 125.50 | 3.50784 | 1 |

TABLE 14
RPM Ranking Frequencies for CalltoAction, rncemaqacjan04
The FREQ Procedure

| | |
|---|---|
| Frequency | Table |
| Percent | of Collection by rank |

| | |
|---|---|
| Row Pct | rank |

| | | | | |
|---|---|---|---|---|
| Col Pct | CalltoAction | 1 | 2 | Total |

| | | | |
|---|---|---|---|
| Learn more | 4 | 1 | 5 |
| | 40.00 | 10.00 | 50.00 |
| | 80.00 | 20.00 | |
| | 80.00 | 20.00 | |
| Show support | 1 | 4 | 5 |
| | 10.00 | 40.00 | 50.00 |
| | 20.00 | 80.00 | |
| | 20.00 | 80.00 | |
| Total | 5 | 5 | 10 |
| | 50.00 | 50.00 | 100.00 |

TABLE 15
Performance on Major Sites by Elephant, rncemaqacjan04

| | | | impres- | | | |
|---|---|---|---|---|---|---|
| Obs | WEBMASTERID | Elephant | sions | revenue | rpm | rank |
| 1 | 69834 | No | 37641 | 69.00 | 1.83311 | 2 |
| 2 | 69834 | Yes | 83737 | 172.50 | 2.06002 | 1 |
| 3 | 95012 | No | 124001 | 285.00 | 2.29837 | 2 |
| 4 | 95012 | Yes | 85693 | 197.75 | 2.30766 | 1 |
| 5 | 103339 | No | 92240 | 156.25 | 1.69395 | 1 |
| 6 | 103339 | Yes | 98111 | 152.50 | 1.55436 | 2 |
| 7 | 137170 | No | 40525 | 200.75 | 4.95373 | 1 |
| 8 | 137170 | Yes | 56012 | 274.50 | 4.90074 | 2 |
| 9 | 681224 | No | 36642 | 130.50 | 3.56149 | 1 |
| 10 | 681224 | Yes | 33807 | 116.00 | 3.43124 | 2 |

TABLE 16
RPM Ranking Frequencies for Elephant, rncemaqacjan04
The FREQ Procedure

| | |
|---|---|
| Frequency | Table of |
| Percent | Elephant by rank |

| | |
|---|---|
| Row Pct | rank |

| Col Pct | Elephant | 1 | 2 | Total |
|---|---|---|---|---|
| | No | 3 | 2 | 5 |
| | | 30.00 | 20.00 | 50.00 |
| | | 60.00 | 40.00 | |
| | | 60.00 | 40.00 | |
| | Yes | 2 | 3 | 5 |
| | | 20.00 | 30.00 | 50.00 |
| | | 40.00 | 60.00 | |
| | | 40.00 | 60.00 | |
| | Total | 5 | 5 | 10 |
| | | 50.00 | 50.00 | 100.00 |

TABLE 17
Performance on Major Sites by DisclaimerPlacement, rncemaqacjan04

| Obs | WEBMASTERID | DisclaimerPlacement | impressions | revenue | rpm |
|---|---|---|---|---|---|
| 1 | 69834 | Bottom | 65701 | 144.25 | 2.1955 |
| 2 | 69834 | Top | 55677 | 97.25 | 1.7466 |
| 3 | 95012 | Bottom | 111576 | 280.25 | 2.5117 |
| 4 | 95012 | Top | 98118 | 202.50 | 2.0638 |
| 5 | 103339 | Bottom | 93361 | 149.50 | 1.6013 |
| 6 | 103339 | Top | 96990 | 159.25 | 1.6419 |
| 7 | 137170 | Bottom | 55002 | 280.00 | 5.0907 |
| 8 | 137170 | Top[ | 41535 | 195.25 | 4.7008 |
| 9 | 681224 | Bottom | 44283 | 157.00 | 3.5453 |
| 10 | 681224 | Top | 26166 | 89.50 | 3.4204 |

TABLE 18
RPM Ranking Frequencies for DisclaimerPlacement, rncemaqacjan04
The FREQ Procedure

| | Table of |
|---|---|
| Frequency | DisclaimerPlacement |
| Percent | by rank |

| | |
|---|---|
| Row Pct | rank |

| | | | | |
|---|---|---|---|---|
| Col Pct | DisclaimerPlacement | 1 | 2 | Total |

| | | | |
|---|---|---|---|
| Bottom | 4 | 1 | 5 |
| | 40.00 | 10.00 | 50.00 |
| | 80.00 | 20.00 | |
| | 80.00 | 20.00 | |
| Top | 1 | 4 | 5 |
| | 10.00 | 40.00 | 50.00 |
| | 20.00 | 80.00 | |
| | 20.00 | 80.00 | |
| Total | 5 | 5 | 10 |
| | 50.00 | 50.00 | 100.00 |

TABLE 19
Performance on Major Sites by ClickButton, rncemaqacjan04

| Obs | WEBMASTERID | ClickButton | impressions | revenue | rpm | rank |
|---|---|---|---|---|---|---|
| 1 | 69834 | No | 70386 | 139.50 | 1.98193 | 2 |
| 2 | 69834 | Yes | 50992 | 102.00 | 2.00031 | 1 |
| 3 | 95012 | No | 110329 | 271.75 | 2.46309 | 1 |
| 4 | 95012 | Yes | 99365 | 211.00 | 2.12348 | 2 |
| 5 | 103339 | No | 96356 | 149.50 | 1.55154 | 2 |
| 6 | 103339 | Yes | 93995 | 159.25 | 1.69424 | 1 |
| 7 | 137170 | No | 43228 | 192.00 | 4.44157 | 2 |
| 8 | 137170 | Yes | 53309 | 283.25 | 5.31336 | 1 |
| 9 | 681224 | No | 37360 | 128.00 | 3.42612 | 2 |
| 10 | 681224 | Yes | 33089 | 118.50 | 3.58125 | 1 |

TABLE 20
RPM Ranking Frequencies for ClickButton, rncemaqacjan04
The FREQ Procedure

| | |
|---|---|
| Frequency | Table of |
| Percent | ClickButton by rank |

| | |
|---|---|
| Row Pct | rank |

| Col Pct | ClickButton | 1 | 2 | Total |
|---|---|---|---|---|
| | No | 1 | 4 | 5 |
| | | 10.00 | 40.00 | 50.00 |
| | | 20.00 | 80.00 | |
| | | 20.00 | 80.00 | |
| | Yes | 4 | 1 | 5 |
| | | 40.00 | 10.00 | 50.00 |
| | | 80.00 | 20.00 | |
| | | 80.00 | 20.00 | |
| | Total | 5 | 5 | 10 |
| | | 50.00 | 50.00 | 100.00 |

TABLE 21
Performance on Major Sites by Image, rncemaqacjan04

| Obs | WEBMASTERID | Image | impressions | revenue | rpm | rank |
|---|---|---|---|---|---|---|
| 1 | 69834 | Bush Outdoors | 66774 | 143.24 | 2.14530 | 1 |
| 2 | 69834 | Bush/Flag | 54604 | 98.25 | 1.79932 | 2 |
| 3 | 95012 | Bush Outdoors | 88582 | 199.50 | 2.25215 | 2 |
| 4 | 95012 | Bush/Flag | 121112 | 283.25 | 2.33874 | 1 |
| 5 | 103339 | Bush Outdoors | 98121 | 161.75 | 1.64847 | 1 |
| 6 | 103339 | Bush/Flag | 92230 | 147.00 | 1.59384 | 2 |
| 7 | 137170 | Bush Outdoors | 52449 | 274.25 | 5.22889 | 1 |
| 8 | 137170 | Bush/Flag | 44088 | 201.00 | 4.55906 | 2 |
| 9 | 681224 | Bush Outdoors | 29243 | 101.00 | 3.45382 | 2 |
| 10 | 681224 | Bush/Flag | 41206 | 145.50 | 3.53104 | 1 |

TABLE 22
RPM Ranking Frequencies for Image, rncemaqacjan04
The FREQ Procedure

| | |
|---|---|
| Frequency | Table |
| Percent | of Image by rank |

| | |
|---|---|
| Row Pct | rank |

| | | | | |
|---|---|---|---|---|
| Col Pct | Image | 1 | 2 | Total |

| | | | |
|---|---|---|---|
| Bush Outdoors | 3 | 2 | 5 |
| | 30.00 | 20.00 | 50.00 |
| | 60.00 | 40.00 | |
| | 60.00 | 40.00 | |
| Bush/Flag | 2 | 3 | 5 |
| | 20.00 | 30.00 | 50.00 |
| | 40.00 | 60.00 | |
| | 40.00 | 60.00 | |
| Total | 5 | 5 | 10 |
| | 50.00 | 50.00 | 100.00 |

TABLE 23
Projected Performance for the full matrix

| Obs | Concept | Color | CalltoAction | Elephant | DisclaimerPlacement | ClickButton | Image | Performance |
|---|---|---|---|---|---|---|---|---|
| 1 | Bulleted | Red/White/Blue | Show | No | Bottom | Yes | Bush | 1.85028 |
| | List | | support | | | | Outdoors | |
| 2 | Bulleted | Dark/Light | Show | No | Bottom | Yes | Bush | 1.84739 |
| | List | | support | | | | Outdoors | |
| 3 | Bulleted | Red/White/Blue | Learn more | No | Bottom | Yes | Bush | 1.84728 |
| | List | | | | | | Outdoors | |
| 4 | Bulleted | Dark/Light | Learn more | No | Bottom | Yes | Bush | 1.84439 |
| | List | | | | | | Outdoors | |
| 5 | Bulleted | Red/White/Blue | Show | Yes | Bottom | Yes | Bush | 1.84428 |
| | List | | support | | | | Outdoors | |
| 6 | Bulleted | Dark/Light | Show | Yes | Bottom | Yes | Bush | 1.84139 |
| | List | | support | | | | Outdoors | |
| 7 | Bulleted | Red/White/Blue | Learn more | Yes | Bottom | Yes | Bush | 1.84128 |
| | List | | | | | | Outdoors | |
| 8 | Bulleted | Dark/Light | Learn more | Yes | Bottom | Yes | Bush | 1.83840 |
| | List | | | | | | Outdoors | |
| 9 | Economy | Red/White/Blue | Show | No | Bottom | Yes | Bush | 1.82504 |
| | | | support | | | | Outdoors | |
| 10 | Bulleted | Red/White/Blue | Show | No | Bottom | No | Bush | 1.82485 |
| | List | | support | | | | Outdoors | |
| 11 | Bulleted | Red/White/Blue | Show | No | Bottom | Yes | Bush/Flag | 1.82472 |
| | List | | support | | | | Outdoors | |
| 12 | Economy | Dark/Light | Show | No | Bottom | Yes | Bush | 1.82218 |
| | | | support | | | | Outdoors | |
| 13 | Economy | Red/White/Blue | Learn more | No | Bottom | Yes | Bush | 1.82207 |
| | | | | | | | Outdoors | |
| 14 | Bulleted | Dark/Light | Show | No | Bottom | No | Bush | 1.82200 |
| | List | | support | | | | Outdoors | |
| 15 | Bulleted | Red/White/Blue | Learn more | No | Bottom | No | Bush | 1.82189 |
| | List | | | | | | Outdoors | |
| 16 | Bulleted | Dark/Light | Show | No | Bottom | Yes | Bush/Flag | 1.82186 |
| | List | | support | | | | | |
| 17 | Bulleted | Red/White/Blue | Learn more | No | Bottom | Yes | Bush/Flag | 1.82175 |
| | List | | | | | | | |
| 18 | Economy | Dark/Light | Learn more | No | Bottom | Yes | Bush | 1.81922 |
| | | | | | | | Outdoors | |
| 19 | Economy | Red/White/Blue | Show | Yes | Bottom | Yes | Bush | 1.81911 |
| | | | support | | | | Outdoors | |
| 20 | Bulleted | Dark/Light | Learn more | No | Bottom | No | Bush | 1.81904 |
| | List | | | | | | Outdoors | |
| 21 | Bulleted | Red/White/Blue | Show | Yes | Bottom | No | Bush | 1.81893 |
| | List | | support | | | | Outdoors | |
| 22 | Bulleted | Dark/Light | Learn more | No | Bottom | Yes | Bush/Flag | 1.81890 |
| | List | | | | | | | |
| 23 | Bulleted | Red/White/Blue | Show | Yes | Bottom | Yes | Bush/Flag | 1.81880 |
| | List | | support | | | | | |
| 24 | Bulleted | Red/White/Blue | Show | No | Top | Yes | Bush | 1.81670 |
| | List | | support | | | | Outdoors | |
| 25 | Economy | Dark/Light | Show | Yes | Bottom | Yes | Bush | 1.81627 |
| | | | support | | | | Outdoors | |
| 26 | Economy | Red/White/Blue | Learn more | Yes | Bottom | Yes | Bush | 1.81616 |
| | | | | | | | Outdoors | |
| 27 | Bulleted | Dark/Light | Show | Yes | Bottom | No | Bush | 1.81608 |
| | List | | support | | | | Outdoors | |
| 28 | Bulleted | Red/White/Blue | Learn more | Yes | Bottom | No | Bush | 1.81598 |
| | List | | | | | | Outdoors | |
| 29 | Bulleted | Dark/Light | Show | Yes | Bottom | Yes | Bush/Flag | 1.81595 |
| | List | | support | | | | | |
| 30 | Bulleted | Red/White/Blue | Learn more | Yes | Bottom | Yes | Bush/Flag | 1.81584 |
| | List | | | | | | | |
| 31 | Bulleted | Dark/Light | Show | No | Top | Yes | Bush | 1.81386 |
| | List | | support | | | | Outdoors | |
| 32 | Bulleted | Red/White/Blue | Learn more | No | Top | Yes | Bush | 1.81375 |
| | List | | | | | | Outdoors | |
| 33 | Economy | Dark/Light | Learn more | Yes | Bottom | Yes | Bush | 1.81331 |
| | | | | | | | Outdoors | |
| 34 | Bulleted | Dark/Light | Learn more | Yes | Bottom | No | Bush | 1.81313 |
| | List | | | | | | Outdoors | |
| 35 | Bulleted | Dark/Light | Learn more | Yes | Bottom | Yes | Bush/Flag | 1.81300 |
| | List | | | | | | | |
| 36 | Bulleted | Dark/Light | Learn more | No | Top | No | Bush | 1.81091 |
| | List | | | | | | Outdoors | |
| 37 | Bulleted | Red/White/Blue | Show | Yes | Top | No | Bush | 1.81081 |
| | List | | support | | | | Outdoors | |
| 38 | Bulleted | Dark/Light | Show | Yes | Top | Yes | Bush | 1.80797 |
| | List | | support | | | | Outdoors | |
| 39 | Bulleted | Red/White/Blue | Learn more | Yes | Top | Yes | Bush | 1.80786 |
| | List | | | | | | Outdoors | |
| 40 | Bulleted | Dark/Light | Learn more | Yes | Top | Yes | Bush | 1.80503 |
| | List | | | | | | Outdoors | |
| 41 | Economy | Red/White/Blue | Show | No | Bottom | No | Bush | 1.79995 |
| | | | support | | | | Outdoors | |
| 42 | Economy | Red/White/Blue | Show | No | Bottom | Yes | Bush/Flag | 1.79982 |
| | | | support | | | | | |
| 43 | Bulleted | Red/White/Blue | Show | No | Bottom | No | Bush/Flag | 1.79964 |
| | List | | support | | | | | |
| 44 | Economy | Dark/Light | Show | No | Bottom | No | Bush | 1.79714 |
| | | | support | | | | Outdoors | |
| 45 | Economy | Red/White/Blue | Learn more | No | Bottom | No | Bush | 1.79703 |
| | | | | | | | Outdoors | |
| 46 | Economy | Dark/Light | Show | No | Bottom | Yes | Bush/Flag | 1.79700 |
| | | | support | | | | | |
| 47 | Economy | Red/White/Blue | Learn more | No | Bottom | Yes | Bush/Flag | 1.79689 |
| 48 | Bulleted | Dark/Light | Show | No | Bottom | No | Bush/Flag | 1.79682 |
| | List | | support | | | | | |
| 49 | Bulleted | Red/White/Blue | Learn more | No | Bottom | No | Bush/Flag | 1.79671 |
| | List | | | | | | | |
| 50 | Economy | Dark/Light | Learn more | No | Bottom | No | Bush | 1.79421 |
| | | | | | | | Outdoors | |
| 51 | Economy | Red/White/Blue | Show | Yes | Bottom | No | Bush | 1.79411 |
| | | | support | | | | Outdoors | |
| 52 | Economy | Dark/Light | Learn more | No | Bottom | Yes | Bush/Flag | 1.79408 |
| 53 | Economy | Red/White/Blue | Show | Yes | Bottom | Yes | Bush/Flag | 1.79398 |
| | | | support | | | | | |
| 54 | Bulleted | Dark/Light | Learn more | No | Bottom | No | Bush/Flag | 1.79390 |
| | Lists | | | | | | | |
| 55 | Bulleted | Red/White/Blue | Show | Yes | Bottom | No | Bush/Flag | 1.79380 |
| | Lists | | support | | | | | |
| 56 | Economy | Red/White/Blue | Show | No | Top | Yes | Bush | 1.79191 |
| | | | support | | | | Outdoors | |
| 57 | Bulleted | Red/White/Blue | Show | No | Top | No | Bush | 1.79173 |
| | Lists | | support | | | | Outdoors | |
| 58 | Bulleted | Red/White/Blue | Show | No | Top | Yes | Bush/Flag | 1.79160 |
| | List | | support | | | | | |
| 59 | Economy | Dark/Light | Show | Yes | Bottom | No | Bush | 1.79130 |
| | | | support | | | | Outdoors | |
| 60 | Economy | Red/White/Blue | Learn more | Yes | Bottom | No | Bush | 1.79120 |
| | | | | | | | Outdoors | |
| 61 | Economy | Dark/Light | Show | Yes | Bottom | Yes | Bush/Flag | 1.79117 |
| | | | support | | | | | |
| 62 | Economy | Red/White/Blue | Learn more | Yes | Bottom | Yes | Bush/Flag | 1.79106 |
| 63 | Bulleted | Dark/Light | Show | Yes | Bottom | No | Bush/Flag | 1.79099 |
| | List | | support | | | | | |
| 64 | Bulleted | Red/White/Blue | Learn more | Yes | Bottom | No | Bush/Flag | 1.79088 |
| | List | | | | | | | |
| 65 | Economy | Dark/Light | Show | No | Top | Yes | Bush | 1.78911 |
| | | | support | | | | Outdoors | |
| 66 | Economy | Red/White/Blue | Learn more | No | Top | Yes | Bush | 1.78900 |
| | | | | | | | Outdoors | |
| 67 | Bulleted | Dark/Light | Show | No | Top | No | Bush | 1.78893 |
| | Lists | | support | | | | Outdoors | |
| 68 | Bulleted | Red/White/Blue | Learn more | No | Top | No | Bush | 1.78882 |
| | List | | | | | | Outdoors | |
| 69 | Bulleted | Dark/Light | Show | No | Top | Yes | Bush/Flag | 1.78880 |
| | List | | support | | | | | |
| 70 | Bulleted | Red/White/Blue | Learn more | No | Top | Yes | Bush/Flag | 1.78869 |
| | List | | | | | | | |
| 71 | Economy | Dark/Light | Learn more | Yes | Bottom | No | Bush | 1.78839 |
| | | | | | | | Outdoors | |
| 72 | Economy | Dark/Light | Learn more | Yes | Bottom | Yes | Bush/Flag | 1.78826 |
| 73 | Bulleted | Dark/Light | Learn more | Yes | Bottom | No | Bush/Flag | 1.78808 |
| | List | | | | | | | |
| 74 | Economy | Dark/Light | Learn more | No | Top | Yes | Bush | 1.78620 |
| | | | | | | | Outdoors | |
| 75 | Economy | Red/White/Blue | Show | Yes | Top | Yes | Bush | 1.78610 |
| | | | support | | | | Outdoors | |
| 76 | Bulleted | Dark/Light | Learn more | No | Top | No | Bush | 1.78602 |
| | Lists | | | | | | Outdoors | |
| 77 | Bulleted | Red/White/Blue | Show | Yes | Top | No | Bush | 1.78592 |
| | Lists | | support | | | | Outdoors | |
| 78 | Bulleted | Dark/Light | Learn more | No | Top | Yes | Bush/Flag | 1.78589 |
| | Lists | | | | | | | |
| 79 | Bulleted | Red/White/Blue | Show | Yes | Top | Yes | Bush/Flag | 1.78579 |
| | Lists | | support | | | | | |
| 80 | Economy | Dark/Light | Show | Yes | Top | Yes | Bush | 1.78330 |
| | | | support | | | | Outdoors | |
| 81 | Economy | Red/White/Blue | Learn more | Yes | Top | Yes | Bush | 1.78320 |
| | | | | | | | Outdoors | |
| 82 | Bulleted | Dark/Light | Show | Yes | Top | No | Bush | 1.78312 |
| | List | | support | | | | Outdoors | |
| 83 | Bulleted | Red/White/Blue | Learn more | Yes | Top | No | Bush | 1.78302 |
| | List | | | | | | Outdoors | |
| 84 | Bulleted | Dark/Light | Show | Yes | Top | Yes | Bush/Flag | 1.78299 |
| | List | | support | | | | | |
| 85 | Bulleted | Red/White/Blue | Learn more | Yes | Top | Yes | Bush/Flag | 1.78288 |
| | List | | | | | | | |
| 86 | Economy | Dark/Light | Learn more | Yes | Top | Yes | Bush | 1.78040 |
| | | | | | | | Outdoors | |
| 87 | Bulleted | Dark/Light | Learn more | Yes | Top | No | Bush | 1.78023 |
| | List | | | | | | Outdoors | |
| 88 | Bulleted | Dark/Light | Learn more | Yes | Top | Yes | Bush/Flag | 1.78009 |
| | List | | | | | | | |
| 89 | Economy | Red/White/Blue | Show | No | Bottom | No | Bush/Flag | 1.77508 |
| | | | support | | | | | |
| 90 | Economy | Dark/Light | Show | No | Bottom | No | Bush/Flag | 1.77230 |
| | | | support | | | | | |
| 91 | Economy | Red/White/Blue | Learn more | No | Bottom | No | Bush/Flag | 1.77220 |
| 92 | Economy | Dark/Light | Learn more | No | Bottom | No | Bush/Flag | 1.76942 |
| 93 | Economy | Red/White/Blue | Show | Yes | Bottom | No | Bush/Flag | 1.76932 |
| | | | support | | | | | |
| 94 | Economy | Red/White/Blue | Show | No | Top | No | Bush | 1.76729 |
| | | | support | | | | Outdoors | |
| 95 | Economy | Red/White/Blue | Show | No | Top | Yes | Bush/Flag | 1.76715 |
| | | | support | | | | | |
| 96 | Bulleted | Red/White/Blue | Show | No | Top | No | Bush/Flag | 1.76698 |
| | List | | support | | | | | |
| 97 | Economy | Dark/Light | Show | Yes | Bottom | No | Bush/Flag | 1.76655 |
| | | | support | | | | | |
| 98 | Economy | Red/White/Blue | Learn more | Yes | Bottom | No | Bush/Flag | 1.76645 |
| 99 | Economy | Dark/Light | Show | No | Top | No | Bush | 1.76452 |
| | | | support | | | | Outdoors | |
| 100 | Economy | Red/White/Blue | Learn more | No | Top | No | Bush | 1.76441 |
| | | | | | | | Outdoors | |
| 101 | Economy | Dark/Light | Show | No | Top | Yes | Bush/Flag | 1.76439 |
| | | | support | | | | | |
| 102 | Economy | Red/White/Blue | Learn more | No | Top | Yes | Bush/Flag | 1.76428 |
| 103 | Bulleted | Dark/Light | Show | No | Top | No | Bush/Flag | 1.76421 |
| | Lists | | support | | | | | |
| 104 | Bulleted | Red/White/Blue | Learn More | No | Top | No | Bush/Flag | 1.76410 |
| | List | | | | | | | |
| 105 | Economy | Dark/Light | Learn more | Yes | Bottom | No | Bush/Flag | 1.76368 |
| 106 | Economy | Dark/Light | Learn more | No | Top | No | Bush | 1.76165 |
| | | | | | | | Outdoors | |
| 107 | Economy | Red/White/Blue | Show | Yes | Top | No | Bush | 1.76155 |
| | | | support | | | | Outdoors | |
| 108 | Economy | Dark/Light | Learn more | No | Top | Yes | Bush/Flag | 1.76152 |
| 109 | Economy | Red/White/Blue | Show | Yes | Top | Yes | Bush/Flag | 1.76142 |
| | | | support | | | | | |
| 110 | Bulleted | Dark/Light | Learn more | No | Top | No | Bush/Flag | 1.76134 |
| | Lists | | | | | | | |
| 111 | Bulleted | Red/White/Blue | Show | Yes | Top | No | Bush/Flag | 1.76124 |
| | Lists | | support | | | | | |
| 112 | Economy | Dark/Light | Show | Yes | Top | No | Bush | 1.75879 |
| | | | support | | | | Outdoors | |
| 113 | Economy | Red/White/Blue | Learn more | Yes | Top | No | Bush | 1.75869 |
| | | | | | | | Outdoors | |
| 114 | Economy | Dark/Light | Show | Yes | Top | Yes | Bush/Flag | 1.75866 |
| | | | support | | | | | |
| 115 | Economy | Red/White/Blue | Learn more | Yes | Top | Yes | Bush/Flag | 1.75856 |
| 116 | Bulleted | Dark/Light | Show | Yes | Top | No | Bush/Flag | 1.75848 |
| | Lists | | support | | | | | |
| 117 | Bulleted | Red/White/Blue | Learn more | Yes | Top | No | Bush/Flag | 1.75838 |
| | Lists | | | | | | | |
| 118 | Economy | Dark/Light | Learn more | Yes | Top | No | Bush | 1.75593 |
| | | | | | | | Outdoors | |
| 119 | Economy | Dark/Light | Learn more | Yes | Top | Yes | Bush/Flag | 1.75580 |
| 120 | Bulleted | Dark/Light | Learn more | Yes | Top | No | Bush/Flag | 1.75563 |
| | List | | | | | | | |
| 121 | Economy | Red/White/Blue | Show | No | Top | No | Bush/Flag | 1.74287 |
| | | | support | | | | | |
| 122 | Economy | Dark/Light | Show | No | Top | No | Bush/Flag | 1.74014 |
| | | | support | | | | | |
| 123 | Economy | Red/White/Blue | Learn more | No | Top | No | Bush/Flag | 1.74003 |
| 124 | Economy | Dark/Light | Learn more | No | Top | No | Bush/Flag | 1.73731 |
| 125 | Economy | Red/White/Blue | Show | Yes | Top | No | Bush/Flag | 1.73721 |
| | | | support | | | | | |
| 126 | Economy | Dark/Light | Show | Yes | Top | No | Bush/Flag | 1.73449 |
| | | | support | | | | | |
| 127 | Economy | Red/White/Blue | Learn more | Yes | Top | No | Bush/Flag | 1.73439 |
| 128 | Economy | Dark/Light | Learn more | Yes | Top | No | Bush/Flag | 1.73167 |

1. A method for optimal determination of advertisements for display, the method comprising the steps of:
(a) selecting a test design keyed to variables relating to an ad;
(b) creating ad media according to the test design;
(c) serving the ad media to ad recipients;
(d) collecting result data regarding the serving/service of the ad media;
(e) analyzing the result data, including (i) obtaining performance data based on the result data, and (ii) determining performance along each variable via processing that includes array mathematics; and
(f) determining projections for the variables.

2. The method of claim 1 wherein the processing includes application of an orthogonal array.

3. The method of claim 2 wherein the processing includes application of a Taguchi methodology to determine the performance.

4. The method of claim 1 wherein the collecting result data step includes tracking the ad media.

5. The method of claim 4 wherein the tracking of the ad media includes tracking how many times each of the ad images was served.

6. The method of claim 4 wherein the tracking of the ad media includes tracking how many clicks are received for the ad images served.

7. The method of claim 4 wherein the tracking of the ad media includes tracking how many conversions result for the ad images served.

8. The method of claim 4 wherein the tracking of the ad media includes tracking information relating to revenue regarding the ad images served.

9. The method of claim 1 wherein, in the serving step, the ad images are distributed in a manner which achieves uniformed/balanced results that thereby enable a correct analysis.

10. The method of claim 8 wherein the ad images are distributed randomly.

11. A method of determining optimal advertisements for display, the method comprising the steps of:
(a) determining one or more variables to analyze;
(b) selecting one or more elements from each of the one or more variables,
wherein the one or more elements are values to which output results of the analysis pertain;
(c) determining combinations of the one or more elements to distribute via application of a test design array/matrix;
(d) creating ad images according to the determined combinations;
(e) serving the ad images to customers;
(f) tracking the ad images to yield results;
(g) analyzing the results, including: (i) obtaining performance data based on the results, and (ii) determining performance along each variable; and
(h) reporting projections for all combinations of variables.

12. The method of claim 11 wherein the tracking step includes tracking how many times each of the ad images was served.

13. The method of claim 11 wherein the tracking step includes tracking how many clicks are received for the ad images served.

14. The method of claim 11 wherein the tracking step includes tracking how many conversions result for the ad images served.

15. The method of claim 11 wherein the tracking step includes tracking information relating to revenue regarding the ad images served.

16. The method of claims 4 or 11 wherein the tracking step includes one or more routines selected from the group consisting of tracking how many times each of the ad images was served, tracking how many clicks are received for the ad images served, tracking how many conversions result for the ad images served, and tracking information relating to revenue regarding the ad images served.

17. The method of claims 4 or 11 wherein the tracking step includes two or more routines selected from the group consisting of tracking how many times each of the ad images was served, tracking how many clicks are received for the ad images served, tracking how many conversions result for the ad images served, and tracking information relating to revenue regarding the ad images served.

18. The method of claims 4 or 11 wherein the tracking step includes three or more routines selected from the group consisting of tracking how many times each of the ad images was served, tracking how many clicks are received for the ad images served, tracking how many conversions result for the ad images served, and tracking information relating to revenue regarding the ad images served.

19. The method of claims 4 or 11 wherein the tracking step includes tracking how many times each of the ad images was served, tracking how many clicks are received for the ad images served, tracking how many conversions result for the ad images served, and tracking information relating to revenue regarding the ad images served.

20. The method of claim 11 wherein, in the serving step, the ad images are distributed in a manner which achieves uniformed/balanced results that thereby enable a correct analysis.

21. The method of claim 20 wherein the ad images are distributed randomly.

22. A method of processing result data obtained from the service of ads to ad recipients, the method comprising the steps of:
(a) identifying variables associated with the ads for analysis;
(b) acquiring a test design array having parameters corresponding to the identified variables;
(c) obtaining first performance data based on result data obtained from service of the ads;
(d) determining second performance data along each of the variables via processing that includes application of an orthogonal array; and
(e) calculating a projection for a best ad to be served.

23. The method of claim 22 wherein the determined performance data is calculated and made available as a first output.

24. The method of claim 22 wherein the second performance data is summary level data for each of the variables and is made available as a second output.

25. The method of claim 22 wherein the determining of second performance data step includes determination of individual placement data that is made available as a third output.

26. The method of claim 22 wherein the calculation of the best ad to be served is made available as a fourth output.

27. The method of claim 22 wherein the determining of second performance data step includes a first calculation of a summary across all network placements, and a second calculation that splits out larger web placements to determine to what extent the variables' effects are established consistently across all placements.

28. The method of any one of claims 4-27 wherein the processing includes application of an orthogonal array.

29. The method of claim 28 wherein the processing includes application of a Taguchi methodology to determine the performance.

30. A system of achieving optimal advertising, including:
(a) an ad banner generating component that generates ads;
(b) an ad server configured to serve the ads to ad recipients;
(c) a processing component configured to process success-related information concerning distribution of the ads;
(d) a database component that stores data concerning the ads; and
(e) a computing component including a computer readable medium embodying a program of instructions concerning the steps of:
(i) selecting a test design keyed to variables relating to an ad;
(ii) collecting result data regarding the service of the ad;
(iii) analyzing the result data, including obtaining performance data based on the result data, and determining performance along each variable via processing that includes array mathematics; and
(iv) determining projections for the variables.

31. The system of claim 30 wherein the array mathematics include application of a Taguchi methodology.

32. A article of manufacture embodying a program of instruction readable by a computer to cause a processor to execute the steps of:
(a) selecting a test design keyed to variables relating to an ad;
(b) creating ad media according to the test design;
(c) serving the ad media to ad recipients;
(d) collecting result data regarding the serving/service of the ad media; and
(e) analyzing the result data, including (i) obtaining performance data based on the result data, and (ii) determining performance along each variable via processing that includes array mathematics; and
(f) determining projections for the variables.

33. The system of claim 32 wherein the array mathematics include application of a Taguchi methodology.
